(19) United States
(12) Patent Application Publication
(10) Pub. No.: US 2005/0171303 A1
(43) Pub. Date: Aug. 4, 2005

(54) Process for marking a thermoplastic composition comprising dynamic cross-linking

(76) Inventors: Philippe P.C.G. Martin, Herstal (BE); Martin Van Duin, Sittard (NL); Marnix Van Gurp, Sittard (NL)

Correspondence Address: MAYER, BROWN, ROWE & MAW LLP, 1909 K STREET, N.W., WASHINGTON, DC, 20006, US

(21) Appl. No.: 10/514,549

(22) PCT Filed: May 21, 2003
(86) PCT No.: PCT/NL03/00378

(30) Foreign Application Priority Data
May 27, 2002 (EP) 02077090.5

(51) Int. Cl. C08L 63/00; C08L 67/00

(52) U.S. Cl. 525/533; 525/438

(57) ABSTRACT

A process for making a thermoplastic composition by dynamic cross-linking of a composition containing a thermoplastic matrix polymer A having functional groups reactive with epoxide groups and a polymer B having epoxide groups and secondary hydroxyl groups, and optionally other components. Separate addition of a cross-linking agent may be omitted.

The invention relates to a process for making a thermoplastic blend composition comprising dynamic cross-linking of a composition comprising a thermoplastic matrix polymer A having functional groups reactive with epoxide groups and 25-80 mass % based on polymer A of a polymer B having epoxide groups. The invention further concerns the product obtainable by said process, and use thereof as thermoplastic elastomer or impact-modifier.

Such a process is known from WO 91/19765 A1. In this patent publication a process for making a thermoplastic composition is disclosed that comprises dynamic cross-linking of a composition comprising 55-30 mass % of a thermoplastic polyester as matrix polymer, e.g. polybutylene terephthalate (PBT), 45-70 mass % of an EPDM rubber functionalised with epoxide groups, and an effective amount of a curing agent, being either a free radical initiator or an organic polyamine, a polyacid, a polyester, a polyanhydride, a polysulfide or a precursor thereof. With such a process a composition comprising a thermoplastic matrix with a cross-linked rubber phase dispersed therein is made, which composition shows elastomeric properties typical for cross-linked rubber, yet is processable as a thermoplastic material.

Such a thermoplastic elastomer is also referred to as thermoplastic vulcanisate (TPV). Vulcanisation, like curing, is used herein as synonym for cross-linking. Dynamic cross-linking or dynamic vulcanisation are the terms generally used in the art to indicate the process of making such a TPV, that is cross-linking of an elastomer or rubber during its melt blending with a molten thermoplastic. More details on dynamic crosslinking, on various TPVs that can be made and on their properties can be found in for example Chapter 7 of Thermoplastic Elastomers, ed. G. Holden, 2^{nd} Ed., Carl Hanser Verlag, 1996 (ISBN 3-446-17593-8), or in Chapter 5 of Polymer Blends and Alloys, eds G. O. Shonaike and G. P. Simon, Marcel Dekker, 1999 (ISBN 0-8247-1980-8). An essential aspect in making a TPV is control over the morphology or microstructure of the blend, that is the particle size of e.g. a dispersed rubber phase, interfacial tension and adhesion between dispersed and matrix phases, and over the extent of cross-linking. Cross-linking of the rubber phase generally allows dispersion of higher amounts of rubber in a polymer matrix, stabilises the obtained morphology by preventing coalescence of rubber particles, and enhances mechanical properties of the blend. In case of making a TPV from a thermoplastic polymer and a rubbery polymer that are compatible with each other, like PP/EPDM TPVs commercially known as Santoprene® or Sarlink®, interfacial tension and adhesion does not present a problem and very finely dispersed cross-linked rubber particles in a PP continuous phase can be obtained, the resulting blend showing good tensile and elastic properties. In case of making a blend from dissimilar, non-compatible polymers, however, like from a polar matrix polymer such as PBT and an apolar rubber such as EPDM, gross phase separation occurs on blending and blends obtained show inferior mechanical properties as a result of weak interfacial adhesion. Like in other polymer alloys, blend compatibilisation in TPVs may result from formation of polymer-polymer grafts and/or block copolymers. Such graft or block copolymers can act as polymeric surfactants to promote and stabilise dispersion of the molten polymers. Block copolymers acting as compatibilisers may be prepared separately and added as an additional component to a blend composition, or be made during blending itself, that is in-situ, e.g. via a chemical reaction between the polymers. An example thereof is reaction of epoxide groups of functionalised EPDM rubber with acid end-groups of PBT, as for example described in WO 91/19765 A1. Such reactive compatibilisation is generally preferred over pre-synthesizing block copolymers, in view of processing simplicity and costs.

A disadvantage of the known process described in WO 91/19765 A1 is, that a cross-linking agent is to be added separately after pre-dispersing the matrix polymer and the rubber. Such separate addition requires close control over dosing, both of amount of cross-linking agent and time and place of addition; and may even require strictly separating processing steps. Furthermore, a suitable cross-linking agent needs to be identified for every combination of polymers in a blend, which agent shows selective reactivity with the rubber phase, and is readily homogeneously dispersible or (selectively) soluble.

It is therefore an object of the present invention to provide a process for making a thermoplastic blend composition comprising dynamic cross-linking that does not show said disadvantage, or at least to a lesser extent.

This object is achieved according to the invention with a process characterised in that polymer B has secondary hydroxyl groups.

With the process according to the invention separate addition of a cross-linking agent is not needed, because the polymer B is self-crosslinking above a certain temperature, as a result of reaction of epoxide groups with secondary hydroxyl groups contained in polymer B.

A further advantage is that the risk of undesired side-reactions during blending, e.g. leading to degradation of polymers in the blend is reduced. Simplicity of the processing operation is a further advantage, blending and cross-linking can be performed in one operation. In addition, high throughputs are possible, while still producing fully reacted products. A further advantage is that cross-link density of polymer B can be varied by varying the total amount of functional groups or the ration of epoxide to secondary hydroxyl groups.

It is true that in a publication in Polymer 42 (2001), p. 2463-2478 a similar process is described, but this relates to making a toughened PBT composition with only 20 mass % of an ethylene-methyl acrylate-glycidyl methacrylate terpolymer (E-MA-GMA) that had been modified by partly reacting with a monocarboxylic acid. This publication presents results of an academic, mechanistic study on interfacial chemistry occurring during blending of PBT with E-MA-GMA, and does not disclose or suggest applying such systems to making blend compositions according to the present invention, or advantageous properties thereof.

The process for making a thermoplastic composition according to the invention comprises dynamic cross-linking of a composition comprising a thermoplastic matrix polymer A having functional groups reactive with epoxide groups. In principle, any polymer with a functional group selected from aliphatic or aromatic hydroxyl, carboxyl, or amine can be used as polymer A. The functional groups may be present as end-groups or as pending groups, and may result from the synthesis of the polymer, or may have been introduced, e.g. by grafting, into the polymer afterwards. Preferably, the functional group is an amine or a carboxylic acid group because of the higher reactivity towards an epoxide group. Most preferred is a polymer wherein the functional groups are carboxylic acid groups, because of favourable reactivity at blending conditions and little risk of side reactions. An additional advantage is that the reaction of carboxyl groups with epoxide groups is faster than the reaction of epoxide groups with secondary hydroxyl groups of polymer B, so that during the process of making the composition dispersion of polymer B in polymer A is enhanced by the formation of block copolymer between A and B before cross-linking of polymer B proceeds to such extent that the morphology obtained is ‘frozen’.

A relatively low amount of functional groups of polymer A is found to be sufficient to allow reaction with the epoxide groups of polymer B and to form an effective amount of graft copolymer as compatibilizer. Since a higher amount of grafting appears to enhance performance of the blend made, suitable polymers contain at least 5 milli-equivalent of functional groups per kilogram of polymer (meq/kg), preferably at least 10 meq/kg, more preferably at least 20. Higher contents may be used, but generally do not lead to markedly better results.

Polymer A may also be a mixture of similar polymers with different content of functional groups, or a mixture of polymer with and without functional groups reactive with epoxide groups. The advantage thereof is that a desirable content of functional groups can also be obtained by blending such polymers in different ratios.

Preferably, engineering thermoplastics with a high softening point, that is either a high melting point (semi-crystalline polymers) or a high glass transition (amorphous polymers) are used as polymers A in the process according to the invention. Examples include aromatic polyesters and polycarbonates, polyamides, polyimides, polysulphones, styrenic polymers, and polyphenylene ethers. A high softening point, e.g. above 150° C., preferably above 200° C. is preferred in order to obtain a blend composition with a high heat distortion temperature. In view of processing ease and chemical resistance, a semi-crystalline polymer is preferred, like a polyamide or polyester. Such thermoplastic polyamides and polyesters generally have carboxylic and/or hydroxyl or amine end-groups, that are reactive towards epoxide groups.

Examples of suitable thermoplastic polyamides are polyamides and copolyamides derived from diamines and dicarboxylic acids and/or from amino carboxylic acids or the corresponding lactams, including aliphatic polyamides such as polyamide 4 (PA 4), PA 6, PA 66, PA 6.10, PA 6.9, PA 6.12, PA 46, PA 66/6, PA 6/66, PA 11, PA 12, and semi-aromatic polyamides such as PA 6/6T, PA 66/6T, PA 6/66/6T, PA 66/61/6T, and mixtures thereof. Preferably polyamide 6, PA 66 or PA 46 or copolymers thereof are chosen. Suitable polyamides have a relative solution viscosity of 1.9-3.0, preferably of 2.0-2.7, and most preferably of 2.0-2.4 (as measured on a 1% solution in 90% formic acid at 25° C.). The polyamide used in the process according to the invention is in particular polyamide 6, in view of its mechanical properties, chemical and thermal resistance, and processability.

Examples of suitable thermoplastic polyesters include essentially linear polyesters and copolyesters made via a condensation reaction of at least one dicarboxylic acid (diacid), or an ester-forming derivative thereof, and at least one dihydric alcohol (diol). The diacid and diol may both be either aliphatic or aromatic, but especially aromatic and partly aromatic polyesters are of interest as thermoplastic moulding materials in view of their high softening points and hydrolytic stability. Fully aromatic polyesters, also referred to as polyarylates, have essentially all ester linkages attached to aromatic rings. They may be semi-crystalline and even show liquid crystalline behaviour, or amorphous.

Partly aromatic polyesters, obtained from at least one aromatic dicarboxylic acid (diacid), or an ester-forming derivative thereof, and at least one aliphatic diol are the preferred polyesters for the present invention. Examples of suitable aromatic dicarboxylic acids include terephthalic acid, 1,4-naphthalenedicarboxylic acid, or 4,4′-biphenyldicarboxylic acid. Suitable aliphatic diols are alkylene diols, especially those containing 2-6 C-atoms, preferably 24 C-atoms. Examples thereof include ethylene glycol, propylene diols and butylene diols. Preferably ethylene glycol, 1,3-propylene diol or 1,4-butylene diol are used, more preferably 1,4-butylene diol. Suitable partly aromatic polyesters are polyalkylene terephthalates, for example polyethylene terephthalate (PET), polypropylene terephthalate (PPT), or polybutylene terephthalate (PBT); polyalkylene naphthalates, for example polyethylene naphthalate (PEN), polybutylene naphthalate (PBN); polyalkylene dibenzoates, for example polyethylene dibenzoate; and blends or copolyesters hereof. Preferably, PET, PBT, PEN and PBN are used, more preferably PBT and PET, because of their commercial availability and advantageous combination of processing and performance properties.

Such partly aromatic polyesters may optionally also contain a minor amount of units derived from other dicarboxylic acids, for example isophthalic acid, or other diols like cyclohexanedimethanol, which generally lowers the melting point of the polyester. The amount of other diacids or diols is preferably limited, unless it is desired to reduce the semi-crystalline character of the polyester.

A special group of partly aromatic polyesters are so-called segmented or block copolyesters that, in addition to polyester segments from the above group of partly aromatic polyesters, called hard segments, also contain so-called soft segments. Such soft segments are derived from a flexible polymer; that is a substantially amorphous polymer with a low glass-transition temperature (T_{g}) and low stiffness, having reactive end-groups, preferably two hydroxyl groups. Preferably the T_{g} is below 0° C., more preferably below −20, and most preferably below −40° C. In principle various different polymers can be used as soft segment, suitable examples are aliphatic polyethers, aliphatic polyesters, or aliphatic polycarbonates. The molar mass of the soft segments may vary within a wide range, but is preferably chosen between 400 and 6000 g/mol. The advantage of using such block copolyesters as polymer A, especially in combination with a rubbery polymer B, is that thermoplastic elastomers can be formed with a unique combination of mechanical and elastomeric properties, and thermal and chemical resistance.

The process for making a thermoplastic composition according to the invention comprises dynamic cross-linking of a composition comprising 25-80 mass % based on polymer A of a polymer B having epoxide groups and secondary hydroxyl groups. These functional groups can be introduced into the polymer already during its synthesis, e.g. by copolymerisation of various functional monomers. Epoxide functional polymers may, for example, be prepared directly via copolymerisation of a monomer like glycidyl methacrylate with olefinic and/or acrylic monomers. Alternatively, one or both of the functional groups may be introduced after preparation of (precursor of) polymer B. Examples hereof include epoxidising a polymer containing unsaturated groups, like natural rubber or a synthetic rubber like ethylene-propylene-diene-monomer rubber (EPDM). Grafting of a rubbery polymer with a epoxide-functional monomer, e.g. glycidyl methacrylate, is another possibility. Secondary hydroxyl groups can subsequently be introduced via reaction of an epoxide group with an amine, hydroxyl, or carboxyl group. Preferably, secondary hydroxyl groups result from reaction with a carboxylic acid group, because the resulting group is only reactive towards epoxide groups above a certain temperature. This allows to prepare the polymer B with both epoxide groups and secondary hydroxyl groups at a certain temperature, for example 200° C., without the risk of premature reaction, and to initiate the reaction between epoxide groups and secondary hydroxyl groups resulting in cross-linking (and reaction with polymer A) only upon increasing the temperature to above for example 250° C. during melt blending with polymer A.

The total amount of functional groups of polymer B that is used in the process according to the invention can in principle vary between wide ranges. Suitable amounts allow both reaction with polymer A as well as reaction between different groups of polymer B to result in self-crosslinking. A higher amount of functional groups generally results in a higher cross-link density of polymer B. In case polymer B is a rubbery polymer, the resulting composition will than show improved elastic properties and improved chemical resistance; e.g. lower swelling of the rubber phase when exposed to solvents. A higher cross-link density also enables making a thermoplastic composition with higher rubber content, also enhancing typical elastic properties, like compression set, of such a composition. If the cross-link density becomes too high, properties will not further improve, but may deteriorate. Suitable contents of functional groups are from 1 to 25 mol % of functional groups, based on monomer of polymer B; preferably from 2 to 15 mol %; more preferably from 3 to 10 mol %.

Polymer B may also be a mixture of different polymers of similar structure but differing in functional groups, like a mixture of functionalised polymer and non-functionalised polymer. This has the advantage that the initial content of functional groups level can be relatively high, but can easily be lowered to a desired level by blending with non-functionalised polymer. It is also possible to use a blend of a polymer with only epoxide groups, a polymer with only secondary hydroxyl groups, and optionally non-functionalised polymer. The advantage thereof is, that only two functionalised polymers need to be pre-synthesized, and that any polymer B composition with certain content of functional groups can be made by simply blending the components. The ratio of epoxide groups to secondary hydroxyl groups may in principle vary between wide ranges, a suitable range is a molar ratio of epoxide to hydroxyl groups from 95/5 to 5/95. In order to enhance cross-linking extent of polymer B, a molar ratio of epoxide to secondary hydroxyl groups from 80/20 to 20/80 is used, more preferably from 70/30 to 30/70, and even more preferably from 60/40 to 40/60.

Polymer B may be a polymer obtainable by contacting a polymer having epoxide groups with a monocarboxylic acid. This functionalization step preparing polymer B having both epoxy and secondary hydroxyl groups may be done in a step preceding blending.

In a preferred embodiment of the process according to the invention, the polymer B is made in a step preceding blending by contacting a polymer having epoxide groups with a monocarboxylic acid, at a molar ratio of epoxide to acid groups from 95/5 to 5/95. These functionalisation and blending steps can be performed separately, but are preferably performed consecutively in one operation, e.g. in one extrusion step with downstream feeding of polymer A. In order to enhance cross-linking extent of polymer B, a molar ratio of epoxide to acid groups from 80/20 to 20/80 is used, more preferably from 70/30 to 30/70, and even more preferably from 60/40 to 40/60. In principle, any monocarboxylic acid can be used, but compounds with low volatility are preferred in view of the processing conditions; that is preferably the boiling point is above 200° C. Aromatic carboxylic acids are preferred in view of the higher thermal stability of the ester formed after reaction with epoxide. Suitable examples include benzoic acid and para-substituted derivatives thereof.

Polymer B can in principle be any polymer having said functional groups. Preferably, polymer B is a rubbery polymer, that is a substantially amorphous polymer with a low glass-transition temperature (T_{g}) and low stiffness. This allows the preparation of thermoplastic compositions that show elastomeric properties; thermoplastic elastomers or TPVs with the process according to the invention. Preferably, the T_{g} is below 0° C., more preferably below −20, even more preferably below −30° C. and most preferably below −40° C. Suitable examples include functionalised natural rubber, e.g. acid-modified epoxidised natural rubber or ethylene-propylene-diene-monomer rubbers (EPDM), and functionalised olefinic copolymers like EPDM, ethylene-propylene rubbers (EPR), other ethylene-alpha-olefin copolymers such as those abbreviated as EPM, EBM, EHM and EOM, including so-called plastomers, or ethylene-acrylic copolymers. Olefinic and acrylic copolymers are preferred in view of their low T_{g} and ease of functionalisation. Specially preferred are olefinic copolymers containing glycidyl methacrylate and a monocarboxylic acid derivative thereof as comonomers or grafted monomers. In a special embodiment E-MA-GMA modified by reaction with para-t-butylbenzoic acid is used as polymer B.

Preferably, the composition made by the process according to the invention comprises at least 30 mass % of polymer B (relative to polymer A), more preferably at least 40, still more preferably at least 45, and most preferably at least 50 mass %. In case polymer B is a rubbery polymer, the flexibility and the elastomeric character of the composition increase with increasing amount of rubber. Depending on the polymer A, the mixing conditions and cross-linking of polymer B, the amount of polymer B used is preferably below 75 mass %, or even below 70 mass %, in order to safeguard that polymer A remains the continuous phase of the composition during the blending process.

The process for making a thermoplastic composition according to the invention comprises dynamic cross-linking of a composition that may further comprise other components. Such components can be any customary additives, like heat- and UV-stabilisers, anti-oxidants, processing aids like mould release agents or lubricants, nucleating agents, colorants, plasticizers, extender oils, filler materials like mineral particles and carbon black, reinforcing agents like glass fibres, flame retarding compounds and anti-dripping agents.

The invention further relates to a thermoplastic composition obtainable by the process according to the invention. Such a composition shows markedly reduced tendency to blooming, also when exposed to higher temperature. The composition shows relatively little smell development during processing, and also little condensation on cold surfaces (fogging) is observed. The composition also shows improved mechanical properties, especially tensile properties, possibly because less degradation of the matrix occurred during preparation. If the polymer B is a rubbery material, the composition shows improved elastomeric properties, like a low compression set, and a reduced tendency to swelling upon exposure to solvents. The composition further shows enhanced thermal stability during melt processing and upon prolonged exposure to higher temperatures. The composition, especially when polymer A is a polyester, shows also improved hydrolytic stability. Furthermore, surface quality of products moulded from the composition is high, with a smooth appearance.

The invention also concerns a process for making a thermoplastic composition comprising dynamic cross-linking of a composition comprising
(i) a thermoplastic matrix polymer A having functional groups reactive with epoxide groups;
(ii) 1-80 mass % based on polymer A of a polymer B having epoxide groups;
(iii) such an amount of a monocarboxylic acid that the molar ratio of epoxide to carboxylic acid is from 95/5 to 5/95; and
(iv) optionally other components. This process has the advantage that functionalisation, compatibilisation and cross-linking can be performed in one operation.

The invention further concerns use of the thermoplastic composition obtainable by the process according to invention as a thermoplastic elastomer, in case polymer B is a rubbery polymer. The enhanced thermal stability, improved tensile properties and reduced blooming/fogging tendency of the composition are typically of advantage in applications where a flexible or elastomeric composition is subjected to higher temperatures during prolonged times, like in under-the-hood automotive applications.

The invention further relates to the use of the thermoplastic composition obtainable by the process according to the invention containing a rubbery polymer B as an impact-modifier for a polymer compatible with the matrix polymer. The present composition already contains a well-dispersed elastomer, which can be used as a concentrate for making an impact-modified composition containing less than 20, or less than 10 mass % of rubbery component, without the mixing process being critical with respect to rubber particle dispersion.

Finally, the invention relates to moulded articles comprising the thermoplastic composition obtainable by the process according to the invention. Such moulded articles also show the advantageous properties of the composition during use.

The invention will now be further illustrated by the following examples and comparative experiments.

Materials

Following materials and abbreviations were used:

| | |
|---|---|
| PBT-1 | a polybutylene terephthalate polymer with about |
| | 49 meq/kg carboxyl end-groups; Mn of about |
| | 19.8 kg/mol; |
| PBT-2 | a polybutylene terephthalate polymer with about |
| | 45 meq/kg carboxyl end-groups; number average molar |
| | mass (Mn) of about 16.1 kg/mol; |
| PBT-3 | a polybutylene terephthalate polymer with about |
| | 7 meq/kg carboxyl end-groups; Mn of about 16.1 kg/mol; |
| E-MA-GMA | Lotader AX8900; an ethylene-methyl acrylate-glycidyl |
| | methacrylate coplymer containing about 24 mass % E |
| | and 8 mass % GMA; Mn about 10 kg/mol; |
| m-E-MA-GMA | modified-E-MA-GMA copolymer wherein 48% of |
| | epoxide groups have been converted into secondary |
| | hydroxyl groups; prepared by mixing Lotader AX8900 |
| | with para-t-butylbenzoic acid at 200° C. during |
| | 15 minutes in a Brabender WE 50H internal mixer. |

### COMPARATIVE EXPERIMENT A

Materials indicated in Table 1 were dried overnight at 25° C. under vacuum, before mixing at 25° C. setting temperature in a Brabender WE 50H internal mixer. The atmosphere in the mixer was controlled by purging with nitrogen gas. PBT was first molten for 1 minute at 30 rpm, than rubber pellets were added and rotation speed was increased to 90 rpm. Total mixing time after addition of all material was 8 min.

Morphology of the obtained composition was studied with optical microscopy, and with Transmission Microscopy (TEM). Samples were first ultra-microtomed at −80° C. into films of about 90 nm thickness, and than stained with RuO4 for one hour before examination in a Philips EM 301 microscope. A dispersed rubber phase in a PBT matrix morphology was observed.

A solvent test was also performed. Compositions were exposed to hot chloroform (CHL), and trifluoroacetic acid (TFA) at room temperature. Since these solvents are good solvents for E-MA-GMA and PBT, respectively, a sample with a single continuous phase would be disintegrated in one of these solvents. In Table 1 a D indicates that the present sample was disintegrated upon exposure to TFA, indicating that the PBT formed the continuous phase. Exposing the sample to chloroform had visually no effect (ND, not disintegrated).

After compression moulding at 250° C. into test bars of 30*5*1.5 mm, Dynamic Mechanical Thermal Analysis (DMTA) was performed with A Rheometrics RSAII apparatus using the tensile mode at a frequency of 1 Hz. From this measurement, the storage modulus of the material at 50° C. was determined.

### EXAMPLE 1

Analogous to Comparative experiment A, a composition was made containing modified-rubber. Again PBT formed the continuous phase, while the modulus of this sample was slightly higher (see Table 1). The observed fine dispersion indicates that compatibilisation as a result of reaction between epoxide groups and PBT acid end-groups was effective.

### EXPERIMENT B AND EXAMPLE 2

The previous experiments were repeated, but now at 60/40 PBT/rubber ratio. In this case E-MA-GMA already tends to form a continuous phase as well (co-continuous), whereas the self-curing rubber remains dispersed in small droplets (see Table 1).

### EXPERIMENT C AND EXAMPLE 3

At a 50/50 ratio both systems appear to form co-continuous structures, be it that Example 3 still has a relatively high modulus.

### EXPERIMENT D AND EXAMPLE 4

At a 40/60 PBT/rubber ratio the non-modified rubber forms a continuous phase with dispersed PBT. In case of self-crosslinking rubber still a co-continuous morphology is observed, as confirmed by the higher modulus (see Table 1).

### EXPERIMENT E-F AND EXAMPLES 5-7

The previous experiments were repeated, but now using a PBT of lower molar mass. The lower viscosity of PBT obviously favours formation of a composition with morphology of dispersed rubber in a PBT matrix, as can be derived from results in Table 1, and TEM observations. It should be noted that at 50/50 ratio the rubber is still dispersed in a PBT matrix, if the rubber phase is cross-linked.

Sample F appeared to show a typical particle-in-particle morphology for the co-continuous rubber phase: apparently some PBT, probably in the form of a graft copolymer, has been entrapped in the rubber phase. Although less prominent, such morphology was also apparent for other samples, but never for those samples based on the self-crosslinking m-E-MA-GMA rubber. It may be concluded that in those blends just enough compatibiliser is formed to secure good and stable dispersion, and that other epoxide groups are involved in cross-linking reactions with pending secondary hydroxyl groups. As a result, the PBT continuous phase remains relatively larger in volume, which favours thermoplastic processing behaviour.

Although in sample 7, containing 70 mass % of rubber, which is even more volume-wise, the rubber also tends to form a continuous phase, it was still not affected by hot chloroform; indicative of effective (self-)crosslinking of the rubber.

Experiment G and Example 8

These experiments at 40/60 PBT/rubber ratio confirmed that only a relatively small amount of carboxylic acids groups in PBT suffice to generate enough reaction between PBT and epoxide-functional rubber to compatibilize the blends (compare data in Table 1 with D-E and 4-5).

TABLE 1

| | Sample composition | | | | | | | |
|---|---|---|---|---|---|---|---|---|
| | (mass %) | | | | | | | |
| | | | | | m-E- | | | Storage |
| Exper- | PBT- | PBT- | PBT- | E-MA- | MA- | Solvent test | | modulus |
| iment | 1 | 2 | 3 | GMA | GMA | CHL | TFA | (MPa) |
| A | 70 | | | 30 | | ND | D | 210 |
| 1 | 70 | | | | 30 | ND | D | 310 |
| B | 60 | | | 40 | | ND | ND | 150 |
| 2 | 60 | | | | 40 | ND | D | 250 |
| C | 50 | | | 50 | | ND | ND | 30 |
| 3 | 50 | | | | 50 | ND | ND | 160 |
| D | 40 | | | 60 | | D | ND | 10 |
| 4 | 40 | | | | 60 | ND | ND | 30 |
| E | | 40 | | 60 | | D | ND | 7 |
| 5 | | 40 | | | 60 | ND | ND | 160 |
| F | | 50 | | 50 | | ND | ND | 95 |
| 6 | | 50 | | | 50 | ND | D | 270 |
| 7 | | 30 | | | 70 | ND | ND | 35 |
| G | | | 40 | 60 | | D | ND | 4 |
| 8 | | | 40 | | 60 | ND | ND | 50 |

1. Process for making a thermoplastic blend composition comprising dynamic cross-linking of a composition comprising a thermoplastic matrix polymer A having functional groups reactive with epoxide groups and 25-80 mass % based on polymer A of a polymer B having epoxide groups, and optionally other components, wherein polymer B has secondary hydroxyl groups.

2. Process according to claim 1, wherein the functional groups of polymer A are carboxylic acid groups.

3. Process according to any one of claims 12 claim 1, wherein polymer A is a polyester.

4. Process according to claim 3, wherein polymer A is polybutylene terephthalate.

5. Process according to claim 1, wherein the polymer B is made in a step preceding blending by contacting a polymer having epoxide groups with a monocarboxylic acid, at a molar ratio of epoxide to acid groups from 95/5 to 5/95.

6. Process according to any one of claims 15 claim 1, wherein polymer B is a rubbery polymer.

7. Process according to claim 6, wherein polymer B is a functionalised olefinic copolymer.

8. Process according to claim 7, wherein polymer B contains glycidyl methacrylate and a monocarboxylic acid derivative thereof.

9. Process according to claim 1, wherein the composition comprises at least 40 mass % of polymer B.

10. Thermoplastic composition obtainable by the process according to claim 1.

11. Process for making a thermoplastic blend composition comprising dynamic cross-linking of a composition comprising (i) a thermoplastic matrix polymer A having functional groups reactive with epoxide groups; (ii) 1-80 mass % based on polymer A of a polymer B having epoxide groups; (iii) such an amount of a monocarboxylic acid that the molar ratio of epoxide to carboxylic acid is from 95/5 to 5/95; and (iv) optionally other components.

12. Use of the thermoplastic composition according to claim 10 as a thermoplastic elastomer.

13. Use of the thermoplastic composition according to claim 10 as an impact-modifier for a polymer compatible with the matrix polymer A.

14. Moulded articles comprising the thermoplastic composition according to claim 10.
